(19) United States
(12) Patent Application Publication
(10) Pub. No.: US 2018/0085993 A1
(43) Pub. Date: Mar. 29, 2018

(54) METHOD FOR PRINTING A THREE-DIMENSIONAL STRUCTURE AND A SYSTEM FOR PRINTING A THREE-DIMENSIONAL STRUCTURE

(71) Applicant: LUXEXCEL HOLDING B.V., Eindhoven (NL)

(72) Inventors: Joris Biskop, Vlissingen (NL); Ricardo Blomaard, Middelburg (NL)

(21) Appl. No.: 15/575,638

(22) PCT Filed: May 20, 2016
(86) PCT No.: PCT/EP2016/061510

§ 371 Date: Nov. 20, 2017

(30) Foreign Application Priority Data
May 22, 2015 (EP) 15169032.8

(51) Int. Cl. B29C 64/112; B29C 35/02; B33Y 10/00; B33Y 30/00; B33Y 40/00; B29C 64/379; B33Y 70/00

(52) U.S. Cl. CPC B29C 64/112; B29C 35/02; B33Y 10/00; B29K 2083/00; B33Y 40/00; B29C 64/379; B33Y 70/00; B33Y 30/00

(57) ABSTRACT

The present invention suggest a method for printing a three-dimensional structure, wherein in a first step a pre-structure is formed by droplets of printing material that are deposited by an inkjet print head, wherein in a second step the pre-structure is provided inside a curing oven for thermal curing, wherein the first step and the second step are repeated till the desired three-dimensional structure is built up.

### BACKGROUND

The present invention relates to a method for printing a three-dimensional structure such as for example hearing aids or light guiding structures.

The idea of inkjet printing of three-dimensional structures is usually based on depositing droplets of printing material that is curable with UV-light. After depositing the droplets are cured by UV-light irradiance. Such a printing process has the advantage of being easy to handle. Another positive aspect is that UV-light triggered curing requires printing machines having a comparatively low complexity. However, UV-curable printing material lack proper durable stability under thermal and UV-light-influence. In detail photo-initiators being needed for UV-curing of the printing material produce aromatic by-products that cause yellowing when the three-dimensional structure is exposed over a long period of time to elevated temperatures or outdoor conditions. Typically the UV-light illumination causes a polymer degradation that in turn results in undesirable stigmas such as increased brittleness and yellowing. Another undesired phenomenon is the polymer shrinkage caused by UV-light triggered curing and the brittleness of the printed three-dimensional structure limits the application possibilities.

### SUMMARY

It is an object of the present invention to provide a method for printing a three-dimensional structure that allows on the one hand a time efficient production of three-dimensional structures and on the other hand avoids the above mentioned disadvantages of the UV-curable printing material, in particular undesired yellowing and brittleness at room and elevated temperatures.

The object is solved by a method for printing a three-dimensional structure, wherein in a first step a pre-structure is formed by droplets of printing material that are deposited by an inkjet print head, wherein in a second step the pre-structure is provided inside a curing oven for thermal curing, wherein the first step and the second step are repeated till the desired three-dimensional structure is built up.

Compared to the state of art it is herewith advantageously possible to avoid UV-light for the final curing in the second step and still print three-dimensional structures in a time economic way. This is made possible by thermal curing of the pre-structure during its stay in the curing oven, wherein in particular thermal curing means a curing process being dependent on temperature, preferably a curing process being accelerated by rising the temperature. Consequently it is possible to accelerate the curing by providing the pre-structure inside the curing oven compared to a pure curing process that is not manipulated by light irradiance or temperature. Especially it is possible to accelerate the curing process without the use of UV light and photo-initiators that lead to yellowness and thermal instability. As a result the quality of the printed article is improved compared to the state of the art by using the method according to the present invention. Moreover using a curing oven has the positive effect of adapting the thermal curing, for example by adjusting the proper temperature or the proper temperature profile across the curing oven. Thus a curing speed, i. e. a time needed for curing the pre-structure in the second step, can be optimized.

In particular, it is provided that for depositing the droplets a nozzle integrated in the inkjet print head is used. The nozzle ejects printing material in shape of droplets toward a substrate and/or the pre-structure. Preferably the printing material is transparent or translucent. In particular, the printing material may be ejected by an inkjet print head of an inkjet printer, wherein the print head is moveable and distributes the droplets of the printing material such that a layer of a plurality of droplets is formed. In particular, the droplets are deposited next and/or above each other. The layer corresponds to an arrangement of droplets within a plane that is substantially parallel to the substrate and/or the pre-structure, for instance. In particular it is also thinkable that the nozzle or the inkjet print head moves and consequently several droplets are arranged next to each other and/or above each other in order to form the layer. Preferably the droplets forming the layer may contact each other or form at least partially a continuous structure because the droplets spread or diffuse before curing. It is also thinkable that the layer is formed by a single pass method, wherein the substrate and/or the pre-structure are moved laterally in the first step in order to spread potential defects being caused by a nozzle failure.

Furthermore it is provided that the pre-structure is transferred to the curing oven in a transfer step between the first and the second step, preferably by using a transfer system. That has the advantage that an area intended for depositing droplets in order to form the pre-structure and an area for curing the pre-structure can be spaced from each other and the space between the inkjet printing head and the curing oven can be overcome by using the transport system. Consequently the pre-structure transported to the curing oven leaves a free space in the area for depositing droplets. This free space can be advantageously used for another forming of a further pre-structure which is intended for a further three-dimensional structure.

Thus the effectivity of printing a plurality of three-dimensional structures can be increased by using the method according to the present invention. Furthermore the space between the area for depositing droplets and the area for curing can be chosen such that an acceleration of curing the printing material in the print head is prevented. Otherwise, such a premature curing in the print head might lead to a blocking, for example inside a nozzle of the inkjet print head. Preferably the pre-structure is moved by the transport system along a closed loop, wherein the three-dimensional structure passes subsequently the inkjet printing head and the curing oven on its way along the closed loop. In particular it is provided that the pre-structures enters the curing oven through a first opening in the curing oven and leaves the curing oven through a second opening in the curing oven, wherein the first and the second opening are preferably located at different, in particular opposing, sides of the curing oven. Furthermore it is thinkable that the pre-structure is retained inside the curing oven at least until the layer is cured. Alternatively it is also conceivable that the pre-structure leaves the curing oven, when the layer is almost cured and the curing is finished on the way back to the printing head. In particular, it is provided that the method is used for printing a three-dimensional structure having a surface roughness less than 10 nanometers RMS. It is also thinkable that the desired three-dimensional structure is polished and/or coated in a final step, in order to further improve the surface properties. Moreover it is preferably provided that the curing oven is an IR buffer oven, i. e. an oven using IR light for heating the layer or the pre-structure. In particular, the curing oven comprises light sources emitting light having a central wavelength between 800 nm and 1500 nm, more preferable between 1000 nm and 1250 nm and most preferably a central wavelength of 1060 nm. It is also thinkable that the temperature is varied inside the oven at least over a period of time during the curing in the second step.

According to another embodiment of the present invention it is provided that in the second step a further pre-structure is formed by droplets of printing material that are deposited by the inkjet print head, wherein in a third step the further pre-structure is preferably provided inside the curing for thermal curing. Preferably it is provided that in the second step the pre-structure is cured in the curing oven and simultaneously the further pre-structure is formed by depositing droplets. It is herewith advantageously possible to realize in a time-saving way several three-dimensional structures by using one system comprising the same inkjet print head and the same curing oven.

According to another embodiment of the present invention it is provided that the three-dimensional structure and the further pre-structure are simultaneously provided, in particular stacked, inside the curing oven in a fourth step. In particular it is provided that the curing oven comprises a mechanical element, such as a lifting system, that is able to rearrange the pre-structure inside the curing oven. Furthermore it is provided that the curing oven is isolated in order to save energy, for example by using isolating material or a sealing system such as a cover or a door that seals the curing oven when no pre-structure enters or leaves the curing oven. It is also thinkable that IR-light sources, in particular light sources emitting IR-light, are integrated in the curing oven. Preferably a homogeneous temperature profile is realized in the curing oven and/or a mean temperature in the oven is between 80° C. and 150° C., more preferably between 120° C. and 130° C. According to another embodiment of the present invention it is provided that in an intermediate step between the first step and the second step the pre-structure is at least partially pre-fixed, preferably by irradiation and particularly preferably by a light pulse. Preferably the outer surface of the pre-structure is pre-fixed by solidification of the surface of the pre-structure. As a result of the pre-fixing the pre-structure is at least partially pre-cured, in particular pinned, and is dimensionally stable for its transport from the area being intended for depositing droplets to the area being intended for curing and especially for its final curing in the curing oven. In particular, it is provided that a surface solidity of the pre-structure formed by depositing droplets is increased by using the irradiation. Thus it is advantageously possible to improve the accuracy of the formed and cured pre-structure. Herewith it is thinkable that the whole pre-structure is illuminated or a part of the pre-structure by using one light pulse or the whole pre-structure is illuminated using a sequence of pulses. Preferably IR-light having a central wavelength between 800 nm and 1500 nm, more preferable between 1000 nm and 1250 nm most preferably a central wavelength of 1060 nm is used for pre-fixing or pre-curing the pre-structure. In particular, it is provided that IR-light pulses having an intensity of more than 4 J/cm² are used. It is also thinkable that visible light is used or that the pre-structure being realized in the first step comprises partially a material having a UV-light reactivity, such as for example a hybrid mixture, and the pre-structure is pre-fixed or pre-cured by a UV-light pulse in the intermediate step. As a consequence it is possible to reduce at least the amount of photo-initiators and consequently the negative effects that are caused by by-products of the photo-initiators. Preferably the light source that emits the light during the intermediate step is located along the transport route between the inkjet print head and the curing oven. In particular, it is provided that the light source that emits the light, in particular the light pulse, in the intermediate step is located immediately next to the print head or next to the area being intended for depositing the droplets. Preferably the pre-structure, in particular the layer, is pre-fixed by a high-intensity light pulse immediately after depositing the droplets that form the pre-structure. Thus the time during which the droplets of the pre-structure can spread is advantageously reduced. Furthermore a shutter is provided, wherein the shutter mainly avoids that light emitted in the intermediate step can get to the inkjet print head. Preferably the shutter is located between the print head and the light source that emits the light in the intermediate step. In particular the shutter is closed during the intermediate step. It is also thinkable that the pre-structure is illuminated during the transport of the pre-structure from the printing head to the curing oven. In another words the transport step and the intermediate step overlap for example at least partially in time. Furthermore it is thinkable the light source that emits light pulses for pre-fixing the pre-structure is integrated in or connected to the inkjet print head.

According to another embodiment of the present invention it is provided that the pre-structure and the further pre-structure, which are arranged together inside the curing oven in the fourth step, are transferred from the curing oven to the inkjet print head one after the other according to a predefined order, wherein the predefined order is preferably controlled by a control unit, such as a computer for example. In particular, it is thinkable that the predefined order is organized by the control unit in order to improve advantageously the time management in the case of printing several three-dimensional structures simultaneously. For example it is thinkable that the time needed for curing the further layer of the further pre-structure is shorter than the time needed for curing the layer of the pre-structure. In such a scenario the control unit organizes the predefined order for leaving the curing oven such that the further three-dimensional structure leaves the curing oven earlier than the pre-structure although the pre-structure entered the curing oven earlier than the further pre-structure. Thus the effectivity of the printing process can be further improved. Furthermore it is provided that the mixture of the printing material is adapted by the control unit. It is also thinkable that the control unit varies the material composition mixture from layer to layer of the pre-structure. It is also thinkable that the control unit is connected to a measuring device that monitors the curing in the oven, determines the pre-defined order based on results of the monitoring on the fly and finally coordinates the subsequent printing based on the pre-defined order. It is also thinkable that the control unit determinates the subsequent depositing of droplets for forming the next layer based on the monitoring in order to compensate potential defects being result of the previous printing process. It is preferably provided that the monitored layer is compared with an expected form of the layer by the control unit. Furthermore it is provided that the control unit determinates a printing strategy based on the information about a planned three-dimensional structure, in particular about a planned three-dimensional structure and a further planned three-dimensional structure, which are made available to the control unit, for example as a CAD-file.

According to another preferred embodiment of the present invention the printing material comprises at least a first component and a second component, wherein preferably the first component comprises vinyl functional silicones and at least partially a catalyst, in particular platinum, and the second component comprises a crosslinker, in particular hydride functional silicones. In particular, it is provided that the catalyst represents a comparatively small fraction of the first component. The first and the second components are preferably mixed together before or during the printing procedure. It is also thinkable that instead of or in addition to platinum another material is used as catalyst such as nickel and/or heavy-metals for example. By mixing the first component and the second component a reaction starts that leads to a curing of the printing material and due to the heating by the curing oven the reaction is advantageously accelerated. Furthermore it is provided that the curing speed is steered by adapting the amount of platinum and/or the amount of the crosslinker in the printing material. It is also thinkable that an additional catalyst is added to accelerate the cure at low temperature. In particular it is provided that the vinyl-functional silicone polymer comprises the group SI—CH═CH₂ and the hydride functional crosslinker comprises the group SI—H. In particular the polymers are end-blocked or multifunctional. It is also thinkable that the curing of the printing material is adapted by a number of pendant reactive sites on the polymer chains or by an inhibitor. Preferably the first component comprises Syl-Off® solventless, platinium-catalyzed Vinyl Silicone materials being available from the firm Dow Corning such as for example Syl-Off® 7680-010, Syl-Off® 7680-020, Syl-Off® 7680-045, Syl-Off® 7395, Syl-Off® 7610, Syl-Off® 7817, Syl-Off® 7612 or Syl-Off® 7780 as first component and a Syl-Off® 7048 crosslinker, a Syl-Off® 7678 crosslinker or Syl-Off® 7682-000 crosslinker as a second component. In particular it is provided that the catalyst is an organo-platinum complex, such as Syl-Off® 4000 catalyst. Preferably the ration between the second component to first component ranges from 1.3:1 to 2.0:1 (calculated and represented as moles SiH: moles Vi or “SiH: Vi ratios”). For example the printing material comprises a material disclosed in WO 2014/160 067 A1 or US 2010 206 477 A1. For an additionally polymerization of the silicones it is provided that the platinum concentration is substantially between 1 ppm and 100 ppm, more preferably between 3 ppm and 75 ppm and most preferably between 5 ppm and 50 ppm. Furthermore it is provided that a Karstedt's catalyst is used. It is also thinkable that a Speier's type catalyst is used. For condensation polymerization of silicones it is preferably provided that the catalyst comprises zinc and/or tin, in particular having a concentration of 100 to 300 ppm. Preferably the printing material comprises a cationic curing silicone ink, a thiol-ene curing silicone ink and/or a free radical silicone ink. It is also thinkable that the printing material comprises an acryllic material, in particular polyacrylate material, as support material for the printing material and preferably silicone as a building material.

According to another embodiment of the present invention it is provided that the first component and the second component are mixed
inside a mixing system connected to the inkjet print head ,
by combining droplets at the exit of the inkjet print head,
by combining droplets in the flight and/or
by combining droplets in the layer.

In particular it is provided that a mixing system connected to the inkjet print head and/or the inkjet print head comprises a mixing zone for an in-situ mixing of the first component and the second component immediately before they are ejected by the nozzle. Preferably the first component and the second component are pre-mixed in the mixing system. In particular, it is provided that the mixing zone comprises a first container including the first component and a second container including the second component. Preferably it is provided that on request the first component from the first container and the second component from the second container are mixed in order to start the curing process. By choosing the way of combining the first component and the second component it is advantageously possible to control the curing process. It is also thinkable that the curing speed is modified through an entire printing process beginning with the first layer on the substrate and ending with the final layer of the three-dimensional structure. It is herewith advantageously possible to steer the accuracy of the respective layer individually by controlling the degree of spreading during the printing.

According to another embodiment of the present invention it is provided that
the pre-structure is arranged on a movable substrate, wherein the substrate is preferably heated, in particular pre-heated,
the substrate is transferred by a transport element, wherein the transport element is preferably heated and/or
the inkjet print head is heated, in particular the printing material inside the print head is heated. It is herewith advantageously possible to warm the layer of the pre-structure, in particular before the pre-structure enters the curing oven, and thus it is possible to further accelerate the curing speed. It is also thinkable that a heating coil is integrated in the substrate or that the substrate is pre-heated, for example in the curing oven or in an oven being intended for pre-heating the substrates. In particular it is provided that the substrate represents a part of the finished three-dimensional structure or the finished three-dimensional structure is removed from the substrate after the printing. Preferably the printing material is preheated inside the inkjet print head to a temperature between 60° C. and 125° C., preferably to a temperature of 100° C. Furthermore it is provided that the substrate is transported on transport elements by clamping the transport element s via vacuum, a mechanical clamping or magnetism. Preferably the temperature of the transport element is higher than the temperature in the area for depositing the droplets. In particular the transport element has a temperature being at least partially greater than 100° C. and more preferably 130° C. It is also thinkable that the substrate and/or the transport element is transferred via a track system. In particular, it is provided that the substrate is moved via a low precision track from the inkjet print head to the curing oven and/or that the substrate is moved via a high precision track from the curing oven to the inkjet printing head, in particular by using the transport element. In particular it is provided that the transport element is rotated in order to average out any defects. Preferably the transport element is rotated in the first step, the second step, the transport step and/or in the intermediate step. It is further provided that the substrate is circular and the transport element is rotated.

According to another embodiment of the present invention it is provided that in the first step a reference mark is provided on or inside the pre-structure, preferably printed on or inside the pre-structure, and/or, wherein the pre-structure is fixed to the substrate adhesively or mechanically. It is also thinkable that the reference mark is a fixed object on the transport element or the substrate. Preferably the reference mark is realized inside or on a layer being formed directly on the substrate. For example the reference mark is a bar code, a QR-code, a line, a number or another visual mark that helps to identify or to orientate the pre-structure for the printing procedure, in particular for depositing the droplets. Thus the alignment of the pre-structure and thus the accuracy of the deposited droplets for forming the next layer can be improved. The reference mark can also help to identify the corresponding pre-structure in the curing oven. Preferably the reference mark is only detectable with light outside the visible range. As a consequence the reference mark cannot be recognized at the finished three-dimensional structure.

According to another embodiment of the present invention it is provided that the pre-structure is fixed to the substrate adhesively or mechanically, in particular by realizing a bonded connection by means of light or by realizing a dispersive adhesion. It is herewith advantageously possible to easily connect the pre-structure to the substrate, in particular via a cohesive, frictional and/or form-fit connection. Preferably a local area of the pre-structure is illuminated by light, in particular by light pulses, immediately after the pre-structure has left the area for depositing droplets. Furthermore the light is preferably focused to one predefined region for connecting the pre-structure to the substrate.

According to another embodiment of the present invention it is provided that a property of the pre-structure, in particular its geometric form and/or its weight, is measured for a potential subsequent corrective measure and/or wherein at least partially an inert atmosphere is used. Preferably the property of the pre-structure is measured during or immediately after depositing droplets in the first step. It is also thinkable that the pre-structure is measured during the curing. Due to the comparatively long curing time, for example 1 minute, it is advantageously possible to measure or monitor the shape of the pre-structure. It is also thinkable that the weight of the pre-structure is measured and based on a difference between an expected value and the measured value a failing of a nozzle is recognized. As a consequence it is possible to initiate timely countermeasures that compensate the failure, for example by adjusting the drive voltage of the print head. It is also thinkable that the pre-structure is measured after it leaves the curing oven. It is herewith advantageously possible to adapt the next layer for the pre-structure based on the measurement. Preferably the control unit is used for adapting the depositing of droplets in dependency on the measurement. The advantage of using an inert atmosphere is a prevention of wear, oxidation processes, safety at elevated temperatures and an improved UV curing process. In particular, the inert gas comprises Nitrogen, Argon, Helium and/or Carbon dioxide. Preferably the entire system for printing a three-dimensional structure is surrounded by the inert atmosphere.

According to another embodiment of the present invention it is provided that the curing oven is a continuous conveyor and/or wherein in a fifth step the pre-structure is arranged inside a cooling zone. The advantage of the continuous conveyor is that the pre-structure can be transported during the curing. By using a cooling zone it is advantageously possible to reduce the probability of defects caused by shrinkage. Preferably the cooling zone is located at the exit of the curing oven. It is further thinkable that a surface of the substrate and/or the cured layer of the pre-structure is treated before droplets of printing material are deposited onto the substrate or the pre-structure. For example the respective surface is modified by a corona treatment in order to increase a surface energy of the cured layer and improve a droplet contact angle.

According to another embodiment it is provided that a light guiding structure is printed. For example the three-dimensional structure is a lens, a Fresnel lens, an optical prism, a filter or an attachment for a light source such as a LED or a flashlight. In particular the method is provided for printing three-dimensional structures that are exposed to elevated temperatures and/or to UV light or sun light over a long period of time. Preferably it is provided to print three-dimensional structures that have direct contact to human skin, such as spectacles or a hearing aid. It is herewith advantageously possible to adapt the method for printing the three-dimensional structure, for example by the proper choice of the printing material, such that a three-dimensional structure is realized having a smooth surface and being at least partially elastic deformable. Thus the wearing comfort of the three-dimensional structure having direct contact to human skin is improved.

Another aspect of the present invention is a system for printing a three-dimensional structure wherein the system comprises
an inkjet print head for depositing droplets of printing material
a curing oven for thermal curing of pre-structures formed by the deposited droplets and
a transport system for transferring the pre-structure from the inkjet print head to the curing oven.

Compared to the state of the art it is herewith advantageously possible to adapt the curing process by the curing oven. In particular, it is possible to establish a specific, in particular homogeneous, temperature profile inside the curing oven. Preferably the inkjet print head is spaced from the curing oven and there is a transport system for transporting the pre-structure between the inkjet printing head and the curing oven. In particular it is provided that the transport system forms a closed loop, wherein the curing oven and the inkjet print head are preferably arranged along the path of the transport system, in particular along the closed loop. Preferably the pre-structure is arranged on a substrate that is transported by a transport element being part of the transport system. It is herewith conceivable that the substrate is part of the finished three-dimensional structure or is removed after the three-dimensional structure has been finished. In particular the system is provided for a method, wherein the three-dimensional structure is realized layer by layer, wherein the layers are stepwise stacked. In particular it is preferably provided that the system is configured for depositing droplets of the printing material in a first step such that they form a predefined layer and subsequently the layer is cured in the curing oven in a second step. By repeating the first step and the second step the pre-structure grows till the desired three-dimensional structure is realized.

According to another embodiment it is provided that a light source emitting light, in particular a light pulse, for pre-fixing, in particular for pinning or pre-curing the pre-structure formed by the deposited droplets is located along a transport route of the pre-structure, wherein the pre-structure is transported via the transport route from the inkjet printing heat to the curing oven. In particular it is provided that light source emitting light pulses is located immediately next to the inkjet printing head.

According to another embodiment it is provided that the curing oven is configured for storing several pre-structures simultaneously and/or wherein the system comprises a cooling zone. By storing several pre-structures inside the curing oven it is possible to print several three-dimensional structures simultaneously. In particular it is possible to adapt the length of time the individual pre-structure stays inside the curing oven. In particular there is no need for adapting the velocity of the transport system in order to satisfy that each pre-structure is cured by storing several three-dimensional structures inside the curing oven. Preferably the pre-structures are stacked inside the curing oven. Thus it is possible to realize a compact curing oven that is easy to heat. In particular, a homogeneous temperature profile can easily be established. For storing the pre-structure inside the curing oven it is thinkable that the pre-structure or the substrate leaves the transport system, at least for a short period of time. Furthermore it is conceivable that the transport system comprises heating elements for heating the substrate and/or the pre-structure.

According to another embodiment of the present invention it is provided that the printing material comprises a first component and a second component, wherein the first component and the second component are configured such that the curing is started when the first component and the second component are mixed, wherein preferably the first component comprises a catalyst, in particular platinum, and vinyl functional silicones, and the second component comprises a crosslinker, in particular hydride functional silicones. Preferably the inkjet print head is heatable and have a mixture zone provided for mixing the first component and the second component. Furthermore it is provided that the print head comprises a mixing system having a first container that comprises the first component and a second container that comprises the second component. In particular it is provided that the mixing system comprises a distributor which coordinates the moment of mixing and the amount of the first component and/or the second component, wherein the distributor is preferably controlled by the control unit.

Another aspect of the present invention is a printed article printed by a method according to the present invention.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

### BRIEF DESCRIPTION OF THE DRAWINGS

FIG. 1 shows in a schematic view a system for printing a three-dimensional structure according to an exemplary embodiment of the present invention.

FIG. 2 shows in a flow diagram a method for printing a three dimensional structure according to an exemplary embodiment of the present invention.

### DETAILED DESCRIPTION

The present invention will be descripted with respect to particular embodiments and with the reference to certain drawings but the invention is not limited thereto but only by the claims. The drawings described are only schematic and are non-limiting. In the drawings, the size of some elements may be exaggerated and not drawn on scale for illustrative purposes.

Where an indefinite or definite article is used when referring to a singular noun, e. G. “a”, “an”, “the”, this includes a plurals of the noun unless something else is specifically stated.

Furthermore, the terms first, second, third and the like in the description and in the claims are used to distinguishing between similar elements and not necessarily for describing a sequential or predefined order. It is to be understood that the terms so used are interchangeable under appropriate circumstances and that the embodiments of the invention described herein are capable of operation in other sequences than described of illustrated herein.

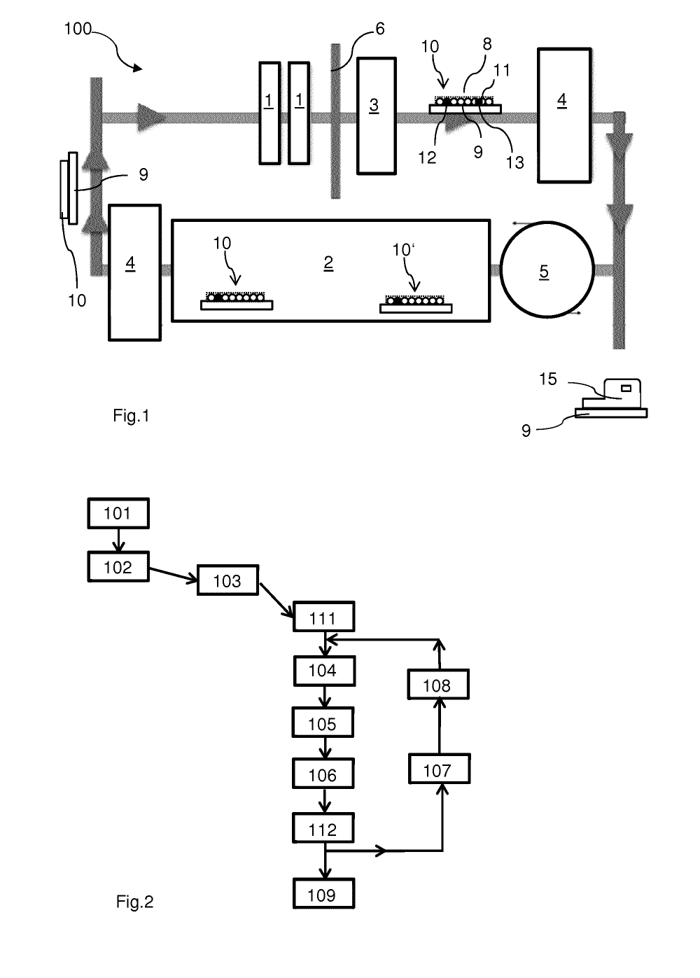

In FIG. 1 a system 100 for printing a three-dimensional structure 15 according to an exemplary embodiment of the present invention is illustrated. Such a system 100 is for example intended to print hearing aids or light guiding structures. Preferably, the system is provided for a method for printing a three-dimensional structure 15, wherein layers 8 of printing material are stacked above each other till a desired three-dimensional structure 15 is formed by the accumulation of the layers 8. In particular, it is provided that in a first step 111 a layer is formed by depositing droplets 11 by an inkjet print head 1 next and/or above each other and in a second step 112 the layer is cured. Preferably it is provided that a pre-structure 10 is gradually built up on a substrate 9. The first and the second step 111 and 112 are repeated till a final layer is formed and the desired final three-dimensional structure 15 is build up. Herewith it is thinkable that in the first step 11 the droplets 11 are deposited in a single pass for forming the layer 8. In such a single pass process the substrate 9 is moved laterally in order to spread defects in the layer 8 that for example are caused by a failing nozzle of the inkjet print head 1. Preferably, it is provided that the printing material comprises a platinum-based catalyst silicone addition cure mixture, wherein a first component and a second component of the platinum-based catalyst silicone cure mixture are mixed in order to start the reaction that results in the curing of the printing material. For example the first component comprises a platinum catalyst and vinyl functional silicones and the second component hydride functional silicones as a crosslinker, wherein a curing speed of the printing material is adapted by a dosage of the platinum and/or a dosage of the crosslinker, in particular by the relative dosage between the platinum and the crosslinker. Furthermore it is thinkable that the first component and the second component are pre-mixed inside a mixing system immediately next to the inkjet print head 1 or are premixed in the first step immediately before the droplets of the printing material are ejected from the inkjet print head 1. Alternatively or additionally it is also conceivable that the first and the second component are mixed by combining droplets 11 at the outlet of the inkjet print head 1, by combining droplets 11 in flight and/or by combining droplets 11 in the layer 8 formed by the deposited droplets 11. It is also thinkable that the printing material comprises an acryllic material, preferably a poly-acrylate material, as support material. In particular, it is provided that in the second step 112 the layer is cured by a thermally accelerated curing, i. e. a curing based on the reactivity of the two components, wherein the curing is accelerated by an elevated temperature or by heating the layer directly or indirectly. For accelerating the reaction, which result in the curing of the printing material, it is also provided that the printing material is heated up to a temperature being greater than 60° C., preferably greater than 100° C. and most preferably being substantially 125° C. Furthermore it is provided that an area for depositing droplets 11, which is preferably defined by the area that includes the inkjet print head 1 and the pre-structure (i. e. an environment of the depositing procedure) is heated in the first step.

Furthermore it is provided that the layer 8 formed by the deposited droplets 11 in the first step 111 is part of a pre-structure 10 that is fixed to a substrate 9 being used for transporting the pre-structure 10 during the entire printing process. In particular, it is provided that in an intermediate step between the first step 111 and the second step 112 the pre-structure 10 is pre-fixed or pre-cured by using light, in particular by a IR-light pulse emitted from pulse light source 3. As a consequence the layer 8 formed by the deposited droplets 11 becomes dimensionally stable for a transport of the pre-structure 10 and especially for the thermal curing. In particular a dispersing of the layer 8 is reduced or prevented by pre-curing the layer 8. Furthermore it is thinkable the light source 3 that emits light pulses for pre-fixing the layer 8 of the pre-structure 10 is integrated in or connected to the print head 1. Preferably it is provided that the pre-structure 10, in particular the layer 8, is illuminated immediately after depositing the droplets 10. It is herewith thinkable that the substrate 9 is transported during the illumination or is stationary. For protection of the inkjet print head 1 against the IR-light pulses there is a high speed shutter 6 provided, wherein the high speed shutter 6 is closed during an illumination of the pre-structure 10 by the light, in particular by the IR-light pulse, and shields most of the IR-light. Moreover the substrate 9 is preferably heated, for example pre-heated or actively heated at least partially during the depositing process and/or during the transport between the curing oven and the inkjet printing head in order to support the acceleration of the reaction that results in the curing of the printing material. In particular, it is provided that the pre-structure 10 is heated via the substrate 9 in order to retain a temperature above a threshold value. It is also thinkable that the printing material comprises a material that is triggered by UV-light for pre-curing or pre-fixed the pre-structure 10, in particular before a thermally accelerated curing occurs.

Furthermore it is provided that in a second step 112 the pre-structure 10 is provided, in particular stored, in a curing oven 2, preferably in an IR buffer oven. In particular, it is provided that the pre-structure 10 being fixed to the substrate 9 is transported to the curing oven 2 and is arranged inside the curing oven 2 by using a transport element 5. For example the substrate 9 is clamped to the transport element 5 via vacuum, mechanical clamping or magnetism and is transported to the curing oven 2. It is also thinkable that the transport element 5 is rotated, for example before the pre-structure 10 enters the curing oven 2, and a circular substrate 9 is used for averaging out potential defects in the layer 8 of the pre-structure 10. Preferably, the transport element 5 organizes the arrangement of the pre-structure 10 inside the curing oven 2. In particular, it is provided that the curing oven 2 is dimensioned and configured for storing a further pre-structure 10′ next to the pre-structure 10, preferably several further pre-structures 10′. For example the curing oven 2 is configured for stacking a plurality of pre-structures 10 and/or further pre-structures 10′. Moreover it is provided that the curing oven 2 is isolated for accumulating energy and/or that a curing oven 2 has homogenous temperature profiles inside. In particular the temperature inside the curing oven 2 is greater than the temperature of the droplets 11 being deposited in the first step 111. Using a curing oven 2 has the advantage of storing the pre-structure 10 and simultaneously forming a further layer for a further three-dimensional structure 10′ during the second step 112. Since depositing the droplets 11 of printing material is completed earlier than curing the layer 8, it is herewith advantageously possible to accommodate the time of curing the layer 8 for realizing a further layer for a further pre-structure 10′. In particular it is provided to arrange, in particular stack or store, several pre-structures 10 inside the curing oven 2. It is also is thinkable that the curing oven 2 has a lift system that is configured
for receiving the substrate 9 in a transport level extending across a plane in which the substrate 9 is transported from the inkjet print head 1 to the curing oven 2,
for lifting the substrate 9 to a storing level, in which the pre-structure 10 is arranged or stored till the printing material of the layer 8 is cured and
for leading back the substrate 9 to the transport level in order to leave the curing oven 2.

It is also thinkable that the system 100 comprises a cooling zone, preferably located immediately at or next to the exit of the curing oven 2. The cooling zone allows controlling the cooling process and thus a probability for defects caused by shrinkage can be advantageously reduced.

Furthermore it is provided that a management of the pre-structure 10 or the further pre-structures 10′ inside the curing oven 2 is organized by a control unit. In particular, a predefined order for leaving the curing oven 2 is steered by the control unit. For example the layer 8 of the further pre-structure 10′ cures faster than the layer 8 of the pre-structure 10. In such a scenario it is coordinated by the control unit that the further pre-structure 10′ leaves the pre-structure 10 earlier although the pre-structure 10′ was arranged inside the curing oven 2 before the further pre-structure 10′ has been entered.

Furthermore it is provided that the system 100 for printing a three-dimensional structure comprises measuring devices 4, in particular in-line measurement devices, which monitor the pre-structure, when the pre-structure 10 leaves the area for depositing droplets and/or the curing oven 2. It is also thinkable that measuring devices 5 for controlling the pre-structure 10 inside the area for depositing droplets 11 and/or inside the curing oven 2 are provided. For example the weight of the pre-structure 10 is measured and compared with an expected value. A difference between the measured weight and the expected value can indicate a failing nozzle and as a consequence of the detected difference the inkjet print head 1 is readjusted, for example by adjusting a drive voltage of the print head 1. It is also thinkable that an optical scanning device such as camera is used as measuring device 4 for monitoring the printing process, in particular for analyzing the layer 8 formed by the deposited droplets 11 of printing material.

Furthermore it is conceivable that an inert atmosphere is used, wherein the inert gas of the inert atmosphere comprises for example Nitrogen, Argon, Helium or carbon dioxide. Such an atmosphere is for example limited to one specific area of the system 100 or is spread over the entire system 100 for printing the three-dimensional structure 15. It is also thinkable that a surface of the printed and cured layer 8 is modified for the droplets of the next layer such that a corresponding surface energy of the surface of the layer 8 is increased. As a consequence a droplet contact angle on the surface can be improved for the droplets 8 of the next layer. An example for such a modification is a corona treatment.

FIG. 2 illustrates in a flow diagram a method for printing a three dimensional structure 15 according to an exemplary embodiment of the present invention, in particular by using a system shown in FIG. 1. It is herewith provided that in the beginning in a first sub-step 101 information about the planned three-dimensional structure 15 are made available, for example as a CAD- file. Based on this CAD-file a strategy for printing the planned and desired three-dimensional structure 15 is created in a second sub-step 102, preferably by the control unit. In the system 100 for printing the three-dimensional structure 103 a substrate is provided in a third sub-step 103, wherein this substrate 9 is preferably pre-heated. For realizing a three-dimensional structure 15 onto the substrate 9 the substrate 9 is mounted on a transport element 5 that transfers the substrate 9 between the area for depositing droplets and the curing oven 2, wherein the transport element 5 is firstly transferred to the inkjet print head 1. Located below the inkjet print head 1 the layer 8 is formed by depositing droplets 11 of printing material onto the substrate 8 in the first step 111. In particular it is provided that a reference mark 12 is printed in the layer 8 that is deposited directly onto the substrate 9. Such a reference mark 13 supports identifying and aligning the pre-structure 10 during the printing procedure. It is also thinkable that the reference mark is realized as a fixed object on the substrate. Subsequently the pre-structure 10 comprising preferably only one layer passes through a shutter 6 that is closed after passing in a fourth sub-step 104. By using an IR-light pulse the pre-structure is pre-fixed or pre-cured such that the surface solidity of the previously formed layer is increased. Subsequently a layer-geometry is measured in the fifth substep, preferably by using a measuring device 104. Preferably the measured layer geometry is used for determining a strategy for depositing droplets 11 for forming a next layer that is arranged on the measured layer 8. In particular, it is provided that the substrate 9 is moved via a low precision track from the inkjet print head 1 to the curing oven 2 in a sixth sub-step. Inside the curing oven 2 the pre-structure 10 is preferably arranged till the printing material of the layer 8 is cured in the second step 112. Subsequently the pre-structure 10 leaves the curing oven 2 and is transferred back to the inkjet print head 1 via a high precision track in seventh sub-step 107. By using the reference marks 12 the pre-structure 10 is aligned and/or orientated for the next layer that is preferably deposited onto the cured layer in the eighth sub-step 108 and subsequently the substrate with the pre-structure 10 passes the shutter 6 again. After deposition the next layer onto the layer the pre-structure 10 repeats the sequence comprising the fourth sub-step 104, the fifths sub-step 105, the sixth sub-step 106, the second step 112, the seventh sub-step 107 and/or the eighth sub-step 108 till the three-dimensional structure 15 is completed in a ninth sub-step 109.

### REFERENCE SIGNS

1 print head
2 curing oven
3 pulse light source
4 measuring device
5 transport element
6 shutter
8 layer
9 substrate
10 pre-structure
10′ further pre-structure
11 droplet
12 reference mark
13 bonded connection
15 three-dimensional structure
100 system
101 first sub-step
102 second sub-step
103 third sub-step
104 fourth sub-step
105 fifth sub-step
106 sixth sub-step
107 seventh sub-step
108 eighth sub-step
109 ninth sub-step
111 first step
112 second step

1. A method for printing a three-dimensional structure, wherein in a first step a pre-structure is formed by droplets of printing material that are deposited by an inkjet print head, wherein in a second step the pre-structure is provided inside a curing oven for thermal curing, wherein the first step and the second step are repeated till the desired three-dimensional structure is built up, wherein in a fourth step the pre-structure and the further pre-structure are simultaneously provided, inside the curing oven.

2. The method according to claim 1, wherein in the second step a further pre-structure is formed by droplets of printing material that are deposited by the inkjet print head, wherein in a third step the further pre-structure is provided inside the curing oven for thermal curing.

3. The method according to claim 1, wherein in an intermediate step between the first step and the second step the pre-structure is at least partially pre-fixed.

4. The method according to claim 3, wherein the pre-structure and a further pre-structure, which are provided together inside the curing oven in the fourth step, are transferred from the curing oven to the inkjet print head according to a predefined order.

5. The method according to claim 1, wherein the printing material comprises at least a first component and a second component, wherein the first component comprises vinyl functional silicones and at least partially a catalyst, and the second component comprises a crosslinker.

6. The method according to claim 5, wherein the first component and the second component are mixed:
inside a mixing system connected to the inkjet print head;
by combining droplets at an exit of the inkjet print head;
by combining droplets in a flight; and/or
by combining droplets in a layer.

7. The method according to claim 1, wherein:
the pre-structure arranged on a movable substrate, wherein the substrate is heated,
the substrate is transferred by a transport element, wherein the transport element is heated and/or
the inkjet print head and/or the printing material inside the print head is heated.

8. The method according to claim 1, wherein in the first step a reference mark is provided on or inside the pre-structure, and/or wherein the pre-structure is fixed to the substrate adhesively or mechanically.

9. The method according to claim 1, wherein a property of the pre-structure is measured for a potential subsequent corrective measure and/or wherein at least partially an inert atmosphere is used

10. The method according to claim 1, wherein the curing oven a continuous conveyor and/or wherein in a fifth step the pre-structure is arranged inside a cooling zone.

11. A system for printing a three-dimensional structure wherein the system comprises:
an inkjet print head for depositing droplets of printing material;
a curing oven for thermal curing of pre-structures formed by the deposited droplets; and
a transport system for transferring the pre-structure from the inkjet print head to the curing oven.

12. The system according to claim 11, wherein the curing oven is configured for storing several pre-structures simultaneously and/or wherein the system comprises a cooling zone.

13. The system according to claim 11, wherein the printing material comprises a first component and a second component, wherein the first component and the second component are configured such that the curing is started when the first component and the second component are mixed, wherein the first component comprises a catalyst and vinyl functional silicones, and the second component comprises a crosslinker.

14. A printed article printed by a method according to claim 1.

15. The method according to claim 3, wherein in the intermediate step between the first step and the second step the pre-structure is at least partially pre-fixed by irradiation.

16. The method according to claim 3, wherein in the intermediate step between the first step and the second step the pre-structure is at least partially pre-fixed by a light pulse.

17. The method according to claim 4, wherein the predefined order is controlled by a control unit.

18. The method according to claim 5, wherein the catalyst is platinum and the crosslinker is hydride functional silicones.

19. The method according to claim 9, wherein the property of the pre-structure is its geometric form and/or its weight.

20. The method according to claim 13, wherein the catalyst is platinum and the crosslinker is hydride functional silicones.
